(19) United States
(12) Patent Application Publication
(10) Pub. No.: US 2024/0011429 A1
(43) Pub. Date: Jan. 11, 2024

(54) CONTROL DEVICE FOR INTERNAL COMBUSTION ENGINE

(71) Applicant: TOYOTA JIDOSHA KABUSHIKI KAISHA, Toyota-shi (JP)

(72) Inventors: Noriya ISHIZAKI, Toyota-shi (JP); Haruto URA, Toyota-shi (JP)

(73) Assignee: TOYOTA JIDOSHA KABUSHIKI KAISHA, Toyota-shi (JP)

(21) Appl. No.: 18/319,083

(22) Filed: May 17, 2023

(30) Foreign Application Priority Data
Jul. 11, 2022 (JP) 2022-111377

(51) Int. Cl. F02B 39/16; G07C 5/08

(52) U.S. Cl. CPC F02B 39/16; G07C 5/0808

(57) ABSTRACT

Provided is a control device for an internal combustion engine provided with a turbocharger, wherein the turbocharger includes a compressor, and the control device includes a first acquisition unit configured to acquire a temperature of a housing of the compressor, and a determination unit configured to determine whether a deposit is generated in the compressor based on the temperature.

### CROSS-REFERENCE TO RELATED APPLICATION

This application is based upon and claims the benefit of priority of the prior Japanese Patent Application No. 2022-111377, filed on Jul. 11, 2022, the entire contents of which are incorporated herein by reference.

### FIELD

The present disclosure relates to a control device for an internal combustion engine.

### BACKGROUND

An internal combustion engine equipped with a turbocharger is known as disclosed in, for example, International Publication No. 2013/080600 (Patent Document 1).

### SUMMARY

When deposits are generated in the compressor of the turbocharger, the efficiency of the turbocharger decreases. Therefore, an object of the present disclosure is to provide a control device for an internal combustion engine capable of determining generation of deposits.

In one aspect of the present disclosure, there is provided a control device for an internal combustion engine provided with a turbocharger, wherein the turbocharger includes a compressor, and wherein the control device includes: a first acquisition unit configured to acquire a temperature of a housing of the compressor; and a determination unit configured to determine whether a deposit is generated in the compressor based on the temperature.

The determination unit may determine that the deposit is generated when the temperature is equal to or higher than a predetermined temperature.

The control device may further include: a second acquisition unit configured to acquire a concentration of insolubles of oil; and a third acquisition unit configured to acquire an amount of decrease in efficiency of the compressor based on the temperature and the concentration of insolubles.

The third acquisition unit may acquire a first decrease rate, which is a rate of decrease in efficiency of the compressor due to the temperature, and a second decrease rate, which is a rate of decrease in efficiency of the compressor due to the concentration of insolubles, and the third acquisition unit may acquire the amount of decrease in efficiency of the compressor based on the first decrease rate and the second decrease rate.

The control device may further include: a fourth acquisition unit configured to acquire a temperature of air in the compressor; and an estimation unit configured to estimate a part where the deposit adheres based on the temperature of the air, wherein the third acquisition unit acquires the amount of decrease in efficiency of the compressor based on the part where the deposit adheres.

### BRIEF DESCRIPTION OF THE DRAWINGS

FIG. 1 is a schematic view illustrating an engine system in accordance with a first embodiment;

FIG. 2 illustrates a relationship between a temperature and a rate of decrease in efficiency;

FIG. 3 illustrates a process executed by an ECU;

FIG. 4 illustrates a relationship between a concentration of insolubles and a rate of decrease in efficiency;

FIG. 5 illustrates a process executed by the ECU;

FIG. 6A is a cross-sectional view illustrating a compressor, and FIG. 6B is a schematic view illustrating a rate of decrease in efficiency; and

FIG. 7 illustrates a process executed by the ECU.

### DETAILED DESCRIPTION

### First Embodiment

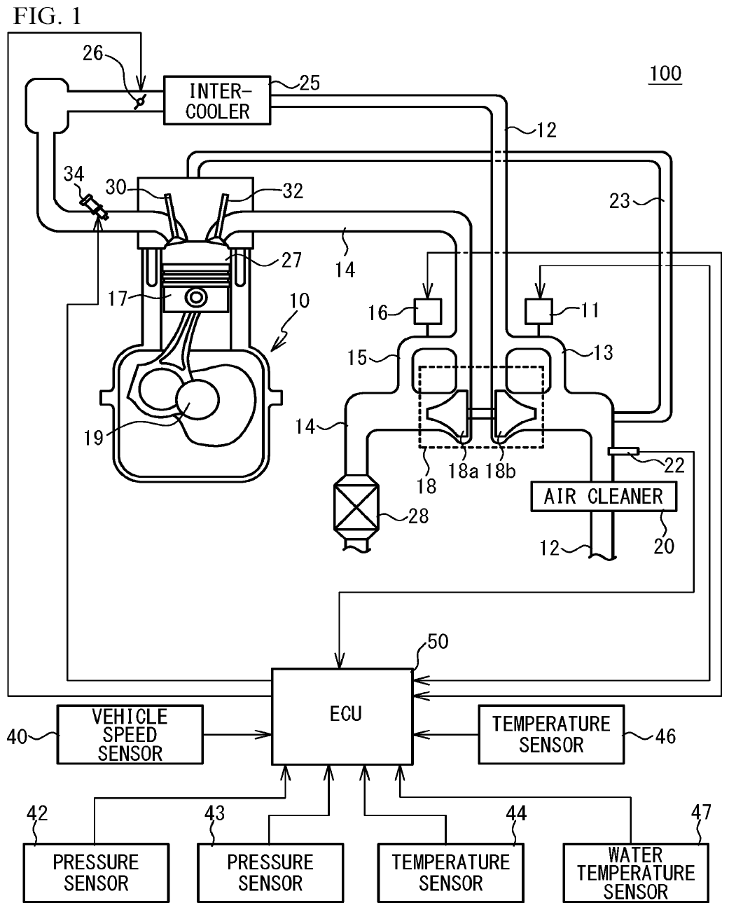

FIG. 1 is a schematic view illustrating an engine system 100 in accordance with a first embodiment. The engine system 100 includes an internal combustion engine 10, a turbocharger 18, and an electronic control unit (ECU) 50.

The internal combustion engine 10 is, for example, a gasoline engine or a diesel engine, and includes a piston 17, an intake valve 30, an exhaust valve 32, and a fuel injection valve 34. A combustion chamber 27 is formed in the bore of the internal combustion engine 10. Although the fuel injection valve 34 is provided in an intake passage 12, it may be provided in the combustion chamber 27. The piston 17 is disposed inside the combustion chamber 27 and is connected to a crankshaft 19.

The intake passage 12 and an exhaust passage 14 are connected to the internal combustion engine 10. The intake passage 12 is provided with an air cleaner an air flow meter 22, an intercooler 25, a throttle valve 26, and the fuel injection valve 34 in this order from the upstream side. A catalyst 28 is provided in the exhaust passage 14.

The turbocharger 18 includes a turbine 18a and a compressor 18b. The turbine 18a and the compressor 18b are connected to each other. The turbine 18a is located upstream of the catalyst 28 in the exhaust passage 14. The compressor 18b is located downstream of the air flow meter 22 and upstream of the intercooler 25 in the intake passage 12. The turbine 18a and the compressor 18b are housed inside a housing (not illustrated).

A bypass passage 13 bypassing the compressor 18b is connected to the intake passage 12, and a valve 11 is provided in the bypass passage 13. When the accelerator is off, the air bypasses the compressor 18b through the bypass passage 13 from downstream to upstream. A bypass passage 15 bypassing the turbine 18a is connected to the exhaust passage 14, and a valve 16 is provided in the bypass passage 15.

A positive crankcase ventilation (PCV) passage 23 is connected to the internal combustion engine 10 and to a position in the intake passage 12 upstream of the compressor 18b of the turbocharger 18. The blow-by gas is returned to the intake passage 12 through the PCV passage 23 and flows through the intake passage 12 together with air. Oil is mixed into blow-by gas. Deposits are generated from insolubles contained in the oil and adhere to the compressor 18b. When the deposits adhere to the turbocharger 18, the efficiency of the turbocharger 18 decreases.

Intake air passes through the intake passage 12, is purified by the air cleaner 20, and is cooled by the intercooler 25. When the intake valve 30 is opened, intake air is introduced into the combustion chamber 27 of the internal combustion engine 10. The fuel injection valve 34 injects fuel into the combustion chamber 27. When a spark plug (not illustrated) is ignited, a mixture of intake air and fuel is combusted in the combustion chamber 27. The piston 17 reciprocates up and down in the combustion chamber 27, and the driving force is transmitted to the crankshaft 19 to drive the vehicle.

When the exhaust valve 32 is opened, exhaust gas generated by combustion is discharged to the exhaust passage 14. The exhaust gas is purified by the catalyst 28 in the exhaust passage 14 and is discharged. The catalyst 28 is, for example, a three-way catalyst, and purifies carbon monoxide (CO), hydrocarbon (HC), nitrogen oxide (NOx), and the like in the exhaust gas.

When the exhaust gas is introduced into the turbine 18a of the turbocharger 18, the turbine 18a rotates, and the compressor 18b connected to the turbine 18a also rotates. Intake air is supercharged by rotation of the compressor 18b, and intake air having a pressure higher than that of intake air on the upstream side of the compressor 18b is fed into the combustion chamber 27 of the internal combustion engine 10.

The engine system 100 includes the air flow meter 22, a vehicle speed sensor 40, pressure sensors 42 and 43, temperature sensors 44 and 46, and a water temperature sensor 47. The air flow meter 22 detects the flow rate of intake air. The vehicle speed sensor 40 detects the speed (vehicle speed) of the vehicle on which the engine system 100 is mounted. The pressure sensor 42 detects the atmospheric pressure. The pressure sensor 43 detects a pressure (supercharging pressure) of the air supercharged by the turbocharger 18. The temperature sensor 44 detects the temperature of the outside air. The temperature sensor 46 detects the temperature in the intake passage 12. The water temperature sensor 47 detects the temperature of the cooling water of the internal combustion engine 10.

The ECU 50 is a control device for the internal combustion engine 10. The ECU 50 includes an arithmetic device such as a central processing unit (CPU) and storage devices such as a random-access memory (RAM) and a read only memory (ROM). The ECU 50 performs various types of control by executing programs stored in the ROM or the storage device.

The ECU 50 controls the opening degree of the throttle valve 26 and the opening degrees of the valves 11 and 16. The valve 11 is an air bypass valve (ABV), and can release the supercharged air by opening when the accelerator is OFF. The ECU 50 switches ON/OFF of fuel injection from the fuel injection valve 34 to control the fuel injection amount.

The ECU 50 acquires the flow rate of intake air from the air flow meter 22, acquires the vehicle speed from the vehicle speed sensor 40, and acquires the fuel injection amount. The ECU 50 acquires the atmospheric pressure from the pressure sensor 42, and acquires the pressure of the air introduced into the compressor 18b based on the atmospheric pressure. The ECU 50 acquires the supercharging pressure from the pressure sensor 43. The ECU 50 acquires the temperature of the outside air from the temperature sensor 44, acquires the temperature of the air in the intake passage 12 from the temperature sensor 46, and acquires the water temperature from the water temperature sensor 47. The ECU 50 calculates the member temperature (housing temperature) of the compressor 18b and the concentration of insolubles of the oil from these pieces of information. The ECU 50 functions as a first acquisition unit that acquires the temperature of the housing of the compressor 18b and as a determination unit that determines whether a deposit has been generated.

When deposits adhere to the compressor 18b, the efficiency is reduced. A decrease in efficiency may be referred to as deterioration of the turbocharger 18. The number of deposits generated depends on the temperature of the compressor 18b and the concentration of insolubles contained in the oil. The oil is mixed into the blow-by gas. The blow-by gas is introduced into the compressor 18b of the turbocharger 18 together with the intake air. Oil adheres to the housing of the compressor 18b. When the temperature of the compressor 18b rises, the oil is likely to evaporate. When the oil evaporates, insolubles contained in the oil are condensed and hardened, and adhere to the compressor 18b as deposits. When the deposits adhere to the compressor 18b, the efficiency of the compressor 18b is reduced.

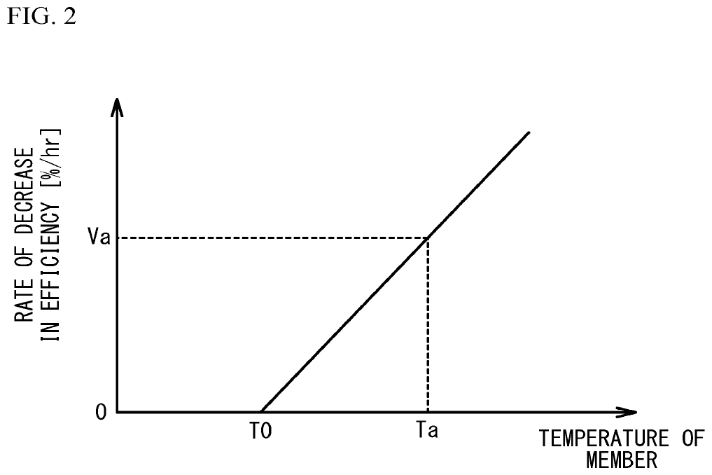

FIG. 2 illustrates a relationship between a temperature and a rate of decrease in efficiency. The horizontal axis represents the temperature of the member (temperature of the housing) of the compressor 18b. The vertical axis represents the rate of decrease in efficiency of the compressor 18b. As illustrated in FIG. 2, when the temperature is lower than TO, the rate of decrease in efficiency is zero. When the temperature is TO, no deposits are generated, and thus no reduction in efficiency due to deposits occurs. On the other hand, when the temperature is equal to or higher than TO, the rate of decrease in efficiency increases to be higher than 0. When the temperature becomes equal to or higher than TO, deposits are generated, and the efficiency of the compressor 18b is also reduced because of the deposits. As the temperature increases, the amount of deposits generated increases. Therefore, the rate of decrease in efficiency is also increased.

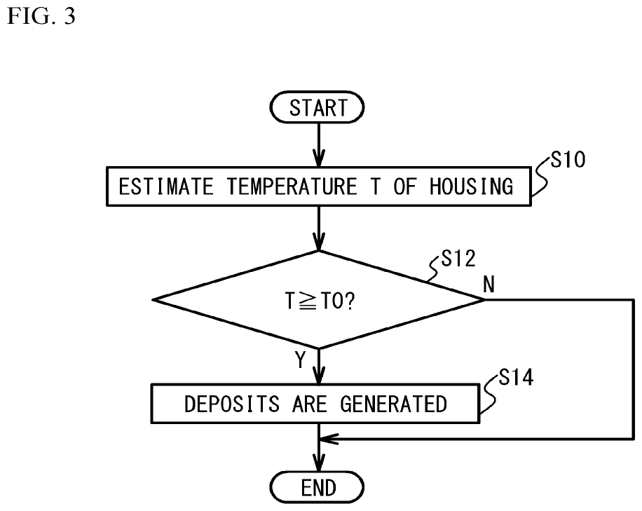

FIG. 3 illustrates a process executed by the ECU 50. The ECU 50 estimates the temperature T of the housing (step S10). For example, the ECU 50 estimates the temperature of the air at the outlet of the compressor 18b from the pressure at the inlet of the compressor 18b, the supercharging pressure, the temperature of the intake air, the flow rate of the intake air, and the vehicle speed. The ECU 50 estimates the temperature T of the housing based on the temperature of the air at the outlet.

The ECU 50 determines whether the temperature T of the housing is equal to or greater than a predetermined temperature TO (step S12). When the determination in step S12 is negative (No) in step S12, the ECU 50 terminates the process of FIG. 3. On the other hand, when the determination in step S12 is affirmative (Yes), the ECU 50 determines that deposits are generated (step S14). After step S14, the process of FIG. 3 ends.

In the first embodiment, the ECU 50 determines whether deposits have been generated in the compressor 18b based on the temperature T of the housing of the compressor 18b. By predicting the generation of deposits, it is also possible to predict a decrease in efficiency of the compressor 18b due to the adhesion of deposits.

The ECU 50 determines that deposits are generated when the temperature T of the housing is equal to or higher than TO (step S14 in FIG. 2). As illustrated in FIG. 2, when the temperature T is less than TO, it is expected that no deposits will be generated and the efficiency will not decrease. When the temperature T is equal to or higher than TO, insolubles in the oil are concentrated and deposits are generated. That is, the temperature at which insolubles in the oil are chemically changed and become deposits is TO. By comparing the temperature T acquired by the ECU 50 with TO, it is possible to accurately predict the generation of deposits. The threshold value TO may be determined in accordance with, for example, the vehicle type, the size and material of the housing, and the like.

To improve the performance of the internal combustion engine 10, it is important to increase the supercharging pressure by the turbocharger 18. By increasing the supercharging pressure, the temperature of the air increases, and the temperature T of the housing also increases. Blow-by gas is recirculated to intake air. When the oil in the blow-by gas is exposed to a high temperature, deposits are generated. As described above, based on the temperature T of the housing and the threshold value T0, the ECU 50 predicts the generation of deposits. Both the improvement of the performance of the internal combustion engine 10 and the prediction of the generation of deposits can be achieved.

### Second Embodiment

In a second embodiment, the amount of decrease in efficiency of the compressor 18b is acquired. The engine system 100 illustrated in FIG. 1 is also common to the second embodiment. Description of the same configuration as in the first embodiment will be omitted.

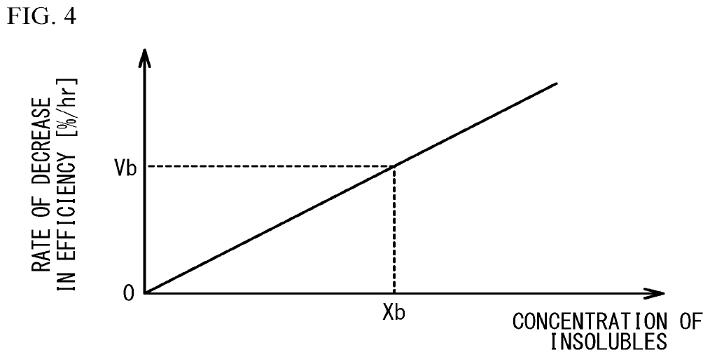

FIG. 4 illustrates a relationship between a concentration of insolubles and a rate of decrease in efficiency. The horizontal axis represents the concentration of insolubles in the oil. The vertical axis represents the rate of decrease in efficiency of the compressor 18b. As illustrated in FIG. 4, as the concentration of insolubles increases, the rate of decrease in efficiency increases. This is because as insolubles are hardened, deposits are generated and adhere to the compressor 18b.

As illustrated in FIG. 2, as the temperature of the member of the compressor 18b increases, the rate of decrease in efficiency also increases. As illustrated in FIG. 4, as the concentration of insolubles in the oil increases, the rate of decrease in efficiency also increases. The ECU 50 functions as a second acquisition unit that acquires the concentration of insolubles. Furthermore, the ECU 50 functions as a third acquisition unit that acquires the amount of decrease in efficiency of the compressor 18b based on the temperature of the member and the concentration of insolubles.

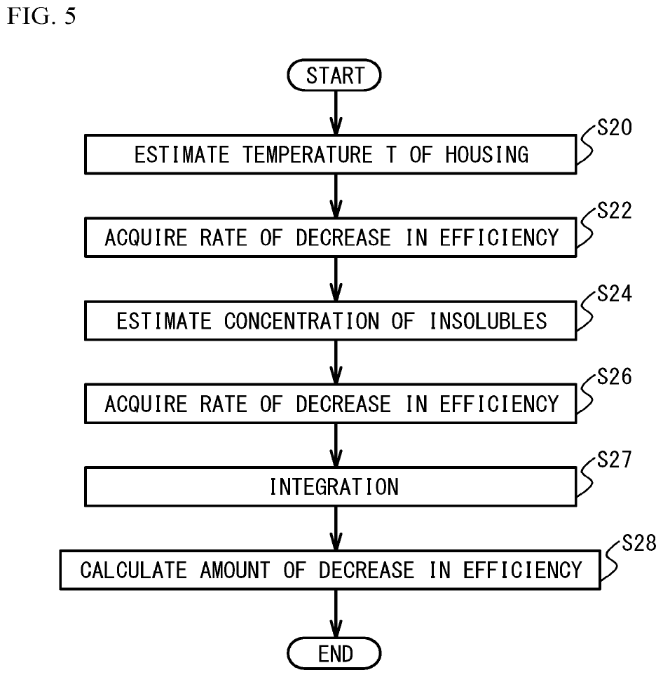

FIG. 5 illustrates a process executed by the ECU 50. The ECU 50 estimates the temperature T of the housing of the compressor 18b (step S20). Step S20 is the same as step S10 in FIG. 3, for example. The ECU 50 acquires the rate of decrease in efficiency corresponding to the temperature T (step S22).

The ECU 50 estimates the concentration of insolubles in the oil (step S24). For example, the ECU 50 acquires the concentration of insolubles on the basis of the fuel injection amount and the temperature of the cooling water. The ECU 50 acquires the rate of decrease in efficiency corresponding to the concentration of insolubles (step S26).

The ECU 50 acquires the rate of decrease in efficiency of the compressor 18b from the rate of decrease in efficiency corresponding to the temperature and the rate of decrease in efficiency corresponding to the concentration of insolubles. The ECU 50 multiplies the rate of decrease in efficiency by the operating time of the internal combustion engine 10, and integrates the amount of decrease in efficiency (step S27). The ECU 50 calculates the amount of decrease in efficacy by integration calculation (step S28). Then, the process of FIG. 5 ends.

In the second embodiment, the ECU 50 acquires the temperature of the housing of the compressor 18b and the concentration of insolubles in the oil. Based on the temperature of the housing of the compressor 18b and the concentration of insolubles, the ECU 50 acquires the amount of decrease in efficiency of the compressor 18b. For example, when the amount of decrease in efficiency reaches a predetermined amount, it is possible to reduce a decrease in efficiency by replacing a component of the compressor 18b.

As illustrated in FIG. 2, the rate of decrease in efficiency (first decrease rate) is determined according to the temperature of the housing of the compressor 18b. For example, when the temperature is Ta, the rate of decrease is Va. As illustrated in FIG. 4, the rate of decrease in efficiency (second decrease rate) is determined according to the concentration of insolubles. For example, when the concentration of insolubles is Xu, the rate of decrease is Vb. When the temperature is Ta and the concentration of insolubles is Xb, the ECU 50 multiplies the rate Va of decrease by the rate Vb of decrease to calculate the rate of decrease in efficiency (Va·Vb) under the condition. By multiplying the rate of decrease (Va·Vb) by the time for which the condition is maintained, the amount of decrease in efficiency is obtained. As in the above example, the rate of decrease according to the conditions (the temperature of the housing and the concentration of insolubles) is multiplied by the duration for which the condition is maintained to obtain the amount of decrease in efficiency. The ECU 50 can acquire the amount of decrease in efficiency of the compressor 18b by integrating the amount of decrease in efficiency for each condition (step S28 in FIG. 5).

The ECU 50 estimates the temperature of the air at the outlet of the compressor 18b from the pressure at the inlet of the compressor 18b, the supercharging pressure, the temperature of the intake air, the flow rate of the intake air, and the vehicle speed. The ECU 50 estimates the temperature of the housing based on the temperature of the air at the outlet. The ECU 50 estimates the concentration of insolubles from the fuel injection amount and the water temperature. That is, the ECU acquires the temperature of the housing and the concentration of insolubles based on the information obtained from the vehicle, and acquires the amount of decrease in efficiency based on the temperature of the housing and the concentration of insolubles. Since the estimation based on the real-time information of the vehicle is performed, the accuracy of the estimation of the amount of decrease in efficiency is improved.

A sensor for detecting the temperature of the housing of the compressor 18b and a sensor for detecting the concentration of insolubles may also be provided in the vehicle. Based on the temperature of the housing and the insolubles detected by the sensors, the ECU 50 can estimate the amount of decrease in efficiency. Further, as described above, the ECU 50 may calculate the outlet temperature of the compressor 18b from the supercharging pressure or the like and calculate the temperature of the housing based on the outlet temperature. The ECU 50 may calculate the concentration of insolubles based on the fuel injection amount and the water temperature. Since the sensor is not provided, an increase in cost can be reduced.

### Third Embodiment

In a third embodiment, the part where deposits adhere in the compressor 18b is predicted. The engine system 100 illustrated in FIG. 1 is also common to the third embodiment. Description of the same configuration as in the first embodiment will be omitted.

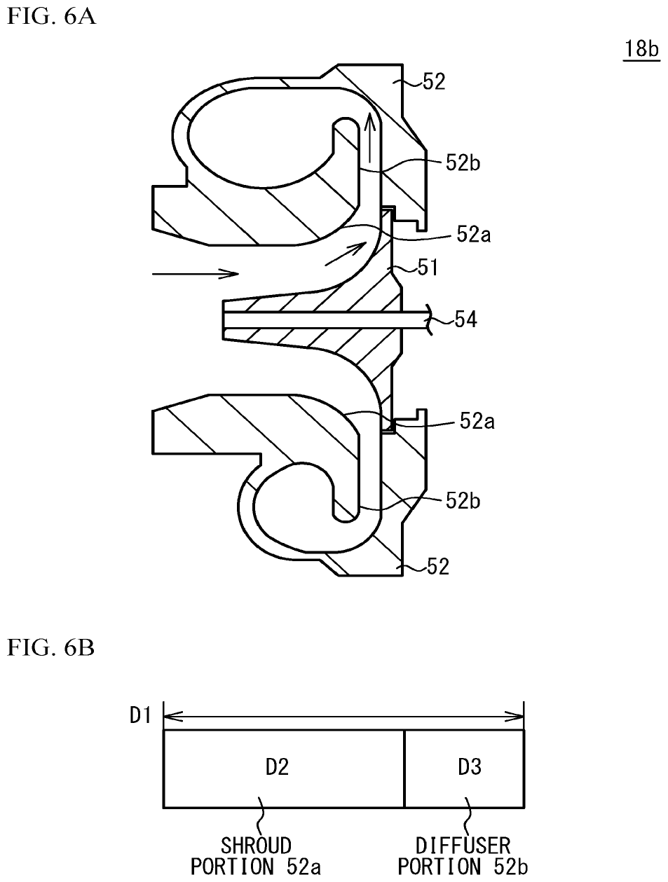

FIG. 6A is a cross-sectional view illustrating the compressor 18b. The compressor 18b has a wheel 51 and a housing 52. The wheel 51 is housed in the housing 52. The wheel 51 is connected to a turbine (not illustrated) by a shaft 54. Air flows through the compressor 18b as indicated by arrows in FIG. 6. The introduced air is supercharged by the rotation of the wheel 51 and fed into the internal combustion engine 10. In the housing 52, a portion on the upstream side in the air flow direction is referred to as a shroud portion 52a, and a portion on the downstream side is referred to as a diffuser portion 52b.

Deposits adhering to the housing 52 reduce the efficiency of the compressor 18b. The amount of decrease in efficiency varies depending on the part where the deposits adhere. The amount of decrease in efficiency caused by the deposits adhering to the shroud portion 52a is larger than the amount of decrease in efficiency caused by the deposits adhering to the diffuser portion 52b.

FIG. 6B is a schematic view illustrating the amount of decrease in efficiency. In the example of FIG. 6B, it is assumed that the amount of decrease in efficiency is D1(%). In D1, the contribution of deposits adhering to the shroud portion 52a is D2(%). In D1, the contribution of deposits adhering to the diffuser portion 52b is D3(%). D2 is larger than D3, for example, about twice D3. The deposits on the shroud portion 52a contribute more to the decrease in efficiency than the deposits on the diffuser portion 52b.

The ECU 50 functions as a fourth acquisition unit that acquires the temperature of the air at the outlet of the compressor 18b (the outlet temperature) and an estimation unit that estimates the part where deposits adhere based on the outlet temperature.

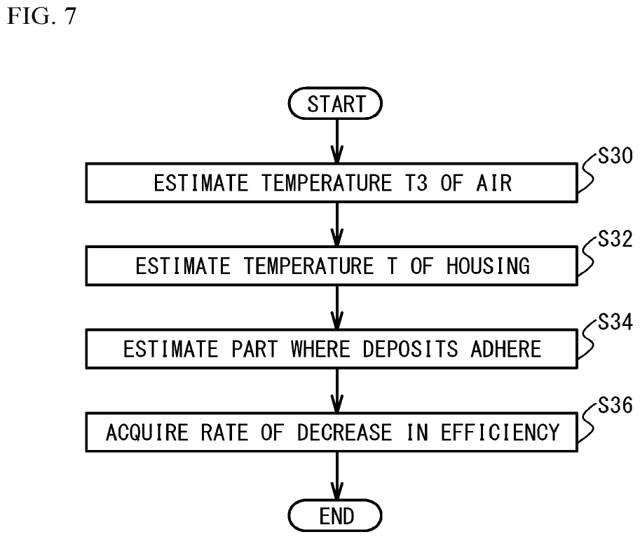

FIG. 7 illustrates a process executed by the ECU 50. The ECU 50 estimates the temperature T3 of the air at the outlet of the compressor 18b (step S30). The ECU 50 estimates the temperature T of the housing of the compressor 18b (step S32). Based on the outlet temperature T3 and the temperature T of the housing, the ECU 50 estimates the part where deposits adhere (step S34). The ECU 50 acquires the rate of decrease in efficiency on the basis of the part where deposits adhere and the temperature T of the housing (step S36). The amount of decrease in efficiency is obtained from the rate of decrease in efficiency (e.g., FIG. 5). Then, the process of FIG. 7 ends.

In the third embodiment, the ECU 50 acquires the outlet temperature, and estimates the part where deposits adhere based on the outlet temperature. As illustrated in FIG. 6B, the deposits on the shroud portion 52a contribute more to the decrease in efficiency than deposits on the diffuser portion 52b. The ECU 50 acquires the rate of decrease in efficiency and also acquires the amount of decrease in efficiency based on the part where deposits adhere. Since the part where deposits adhere is also taken into consideration, the estimation accuracy of the amount of decrease in efficiency is improved.

Although some embodiments of the present invention have been described in detail, the present invention is not limited to the specific embodiments but may be varied or changed within the scope of the present invention as claimed.

What is claimed is:

1. A control device for an internal combustion engine provided with a turbocharger,
wherein the turbocharger includes a compressor, and
wherein the control device comprises:
a first acquisition unit configured to acquire a temperature of a housing of the compressor; and
a determination unit configured to determine whether a deposit is generated in the compressor based on the temperature.

2. The control device for the internal combustion engine according to claim 1, wherein the determination unit determines that the deposit is generated when the temperature is equal to or higher than a predetermined temperature.

3. The control device for the internal combustion engine according to claim 1, further comprising:
a second acquisition unit configured to acquire a concentration of insolubles of oil; and
a third acquisition unit configured to acquire an amount of decrease in efficiency of the compressor based on the temperature and the concentration of insolubles.

4. The control device for the internal combustion engine according to claim 3,
wherein the third acquisition unit acquires a first decrease rate, which is a rate of decrease in efficiency of the compressor due to the temperature, and a second decrease rate, which is a rate of decrease in efficiency of the compressor due to the concentration of insolubles, and
wherein the third acquisition unit acquires the amount of decrease in efficiency of the compressor based on the first decrease rate and the second decrease rate.

5. The control device for the internal combustion engine according to claim 3, further comprising:
a fourth acquisition unit configured to acquire a temperature of air in the compressor; and
an estimation unit configured to estimate a part where the deposit adheres based on the temperature of the air,
wherein the third acquisition unit acquires the amount of decrease in efficiency of the compressor based on the part where the deposit adheres.
